(19) United States
(12) Patent Application Publication
(10) Pub. No.: US 2004/0064476 A1
(43) Pub. Date: Apr. 1, 2004

(54) Computer program, method, and media player

(76) Inventor: John Rounds, Shirley, MA (US)

Correspondence Address: Lawson, Philpot & Persson, P.C., Suite 110, 67 Water Street, Laconia, NH, 03246, US

(21) Appl. No.: 10/261,369

(22) Filed: Sep. 30, 2002

(51) Int. Cl. G06F 7/00

(52) U.S. Cl. 707/104.1

(57) ABSTRACT

A method, computer program product, and media player for creating a playlist from a database of output files. The method involves obtaining a database containing at least two fields corresponding to descriptors of the output files. The basic embodiment assigns a rating descriptor, corresponding to the aesthetic quality of an output file to the user, to one of the database fields and assigns a time descriptor, which records the time of a file's most recent execution, download, modification, or other relevant time based value, in another of the database fields. The output files are then organized into the playlist based upon the output file's rating descriptor, time descriptor, or both.

### FIELD OF THE INVENTION

The present invention relates to the field of digital entertainment media and, in particular to methods, programs and media players that organize stored entertainment media.

### BACKGROUND OF THE INVENTION

Computers are now frequent sights in the home and workplace. As people spent more time on their computers, there has been a greater demand for computerization of traditional types of media, such a songs, pictures, and movies. In response to this demand, special program formats have been developed for audio files (.mp3, .wav, etc.), motion picture files (.mpg, .avi, etc.), and picture files (jpg, git), and a number of computer programs have been developed to run these various types of file. These programs, often called decoders, take the digitized media file and convert it into the music, video, picture or other type of media that the user expects. Some decoders, such as the Nitrane and Fraunhoffer mp3 type file decoders, are designed to convert only one type of media file, while others, such as Windows Media Player, are adapted to decode many different types of file formats. However, each performs on one function; i.e. to take a chosen file and convert that file into the appropriate media.

With Internet capability, a computer has instant access to an incredible amount of media files. Aside from the ability to simply access these media files, a computer is capable of downloading these files, permanently storing them onto a readable drive, and using a decoder to execute them at the will of the user. Traditionally, the computer user needed to manually choose a media file for execution. However, where large numbers of media files have been downloaded, it is often difficult for a user to determine the content of each file in order to choose execute it. Accordingly, the user was forced to waste time sorting through media files before playing them. This waste of time is exacerbated by the fact that many media files are relatively brief. For example, the typical song is approximately only three to four minutes in length. Thus, it is very cumbersome to have to choose a new media file every time that one finishes.

In response to the waste of time that is inherent in manually choosing a media file each time that file was to be executed, a number of media programs have been developed that include a playlist function. A playlist is a string of files that a program executes in a specified order until each file has been executed. There are many methods by which to generate a playlist. For example, a computer may assemble files into a playlist based on the location of the files. As this method depends purely upon file location, it either generates a playlist with no uniformity of media style, or requires that users group media into static computerized folders. In addition, each media file is limited to a single playlist and may not be used in multiple lists preventing, for example, a bluegrass song with incredible violin from being included in both bluegrass and violin based playlists. Further, because these playlist are file location specific, media files are often played in alphabetical order, creating a static list akin to traditional records or tapes. Finally, and most importantly, this method does not take the user's level of enjoyment of a particular song into account when building and playing the list. This is especially important for users, such as disc jockeys, who have an enormous library of songs to satisfy requests, but have a core group of songs, which, absent requests, they wish to play.

Another way for a computer user to generate a playlist is to tediously add files one-by-one to create a playlist. This method allows the user to avoid some of the drawbacks attendant to playlists based upon file location, but involves the same time consuming process required to choose files. Therefore, this method tends to result in the creation of one, or a few, static playlists. In addition, this method prevents the user from easily changing the location of downloaded files, for example from a hard disk to a CD-ROM.

One art-recognized way to overcome the problem of static playlists is to randomize each playlist. This randomization is typically accomplished by randomly choosing one file from the entire playlist before the execution of each media file. Unfortunately, this method requires that the file that was just executed goes back in the list and has the same chance of being played again as every other file within the list. Accordingly, it is often the case that the same file will be executed multiple times before other files are executed once.

There are a number of commercially available programs that utilize playlists. For example, “Playlist—Directory Sync”, published by TBY Software, is a program that searches through a directory containing MP3 type files, and makes sure that they are all listed on a playlist that a user specifies. It can also create a new playlist from the directory, allowing the computer user to customize the download path of each new MP3 type file. This program is much less time consuming than the manual method, as it allows new files to be automatically assigned to a playlist. Further, it allows files to be readily moved from directory to directory. However, this program does not sort files based upon on media style, requiring that the user assign the file to a single playlist. Further, it still creates a stagnant list in which all songs are continuously played in accordance with their order in the playlist.

“BMusic 1.10”, published by innovative Solution Technologies, is program for sorting and decoding music files that ranks all songs in a hard disk according to the number of times a user plays them. As one plays favorite songs more, they will automatically show up at the top of the playlist. Further, a search function allows a user to easily find files in his or her computer by artist or title for incorporation into new playlists. Accordingly, this program makes it easier to develop playlists and takes a user's personal preferences into account during randomization, albeit in a very limited manner. However, this program is severely limited. For example, often a user will be in the mood for a specific genre of music rather than a single artist. Using this program, a user must manually search and build a playlist based upon a search of known artists, creating the same problems described above in connection with the manual creation of playlists. Further, this program puts frequently played songs at the top of playlists, resulting in frequently played songs quickly becoming stale and seldom played songs going unplayed, or requiring the user to constantly skip past tracks to get to them.

“Mp3ListShellEx 1.4”, published by Pitomnik Soft, is a media player add-on program to that allows a user to build many types of mp3 playlists and lists, based on ID3v 1.1 tag and MPEG frame information. The program uses ID3 type identification tags that come with MP3 type files to generate playlists. ID3 tags contain subject matter such as artist, title, album, year, genre, and comments.

Although this program provides for much more individualized control over the content of playlists, it fails in two key ways. First, it does not allow the user to assign a preference or rating to each media file, limiting its usefulness to disc jockeys and others with extremely large media collections. Second, it utilizes a standard randomization process, resulting in the same drawbacks enumerated above.

Therefore there is a need for a means for creating a playlist that does not limit each media file to a single playlist, that does not create static playlists list akin to traditional records or tapes, that takes the user's level of enjoyment of a particular song into account when building the list, that allows the playlist to be randomized such that the same stale songs are less likely to be repeated, and that allows playlists to be created based upon a variety of search criteria, including media style or personal keyword.

### SUMMARY OF THE INVENTION

The present invention is a method, a computer program product, and a media player for creating a playlist from a database of output files, which overcomes the drawbacks inherent in the prior art. In its most basic form, the method for creating a playlist of the present invention involves obtaining a database containing at least two fields corresponding to descriptors of the output files. The basic embodiment assigns a rating descriptor, corresponding to the aesthetic quality of an output file to the user, to one of the database fields and assigns a time descriptor, which records the time of a file's most recent execution, download, modification, or other relevant time based value, in another of the database fields. Finally, the basic embodiment organizes the output files into the playlist based upon the output file's rating descriptor, time descriptor, or both.

In some embodiments, the database contains a number of additional fields and a user further assigns one or more adjective descriptors to the output files. Generally, these adjectives will describe the file's contents, such as “jazz”, “dance”, “swing”, “action”, “drama”, “comedy”, “family”, “brother”, “son”, “daughter”, etc. This adjective descriptor may also describes features of the common media file classes such as “audio”, “video”, and “pictures”, although the method need not be applied only to media files. Similarly, the adjective descriptors listed above are certainly non-exhaustive, as the computer user is master of his own vocabulary and may label files with existing or non-existing words.

In another embodiment, the organizing step further organizes the output files into the playlist based upon a rating descriptor and one or more adjective descriptors of each output files. Output files with a chosen rating and adjective, or range of ratings and adjectives, are included in the list, while the remaining output files are excluded.

Another embodiment communicates the playlist to a means of executing the output files. The means for executing an output file may simply be a decoder designed to execute the particular type of output file, although in the preferred embodiment it is a media player, such as the Windows Media Player described above. This embodiment also updates the time descriptor corresponding to the time of last execution of each of the output files executed during the executing step, allowing playlists to be generated and/or randomized based upon this time of execution.

In another embodiment, the organizing step further organizes output files into a playlist based upon an output file's rating descriptor, any adjective descriptors, and a time descriptor. Much like the preceding embodiment, this embodiment filters output files based on a rating descriptor and a time descriptor and organizes them into a playlist. However, in this embodiment the method accounts for a time descriptor indicating the time of a file's last execution. Files are preferably not excluded from the playlist based on the time descriptor, but rather are organized such that the output files executed most recently will more be less likely to be executed than files executed less recently by a program using the playlist. Conversely, this method might also arrange the output files so that the most recently executed are more likely to be executed by a program using the playlist, if the user so desired, or recently executed files could be excluded from the playlist altogether.

Another embodiment further organizes the output files into the playlist based upon the time descriptor and any adjective descriptors of output files. This embodiment would exclude any output files lacking the user-specified adjective descriptor and then organize the output files in manner such that the output files executed most recently will more be less likely to be executed than files executed less recently by a program using the playlist. Again, it is understood that this embodiment may also arrange the output files so that the most recently executed are more likely to be executed by a program using the playlist, or to exclude recently executed files from the playlist.

Another embodiment of the present invention assigns a rating descriptor and an adjective descriptor by communicating an input prompt to a user, accepting the input and updating the rating descriptor of the output file based upon the input. This embodiment asks a user for any rating descriptors and/or adjective descriptors particular to the user and allows any user to specialize descriptors as he sees fit. When this particular embodiment is used with a machine with a visual display device, i.e. a computer, television, or the like, a form preferably serves as the communication means. In the preferred embodiment, this process may be performed for a single file, or descriptors may be assigned to a group of files at one time.

Another embodiment prompts a user to remove any undesired output files from the playlist. While most embodiments of the basic method depend on program-aided filtration, it is unrealistic to assume that all songs undesirable to the user will vanish. Thus, a user may remove any lingering undesired files from each playlist.

Another embodiment of the present invention assigns a location descriptor to an output file. This location descriptor tracks an output file's location on drive, be it a user's local drive, a network drive or an Internet “url”.

Another embodiment of the present invention assigns an artist descriptor to output files. An artist is a very popular description for a media file. The artist might be a movie producer, a singer, a producer, a photographer or any other significant contributor to the expression a particular media output file.

Finally, still another embodiment organizes the playlist and sends this list to a means for writing to a computer readable storage media, such as a CD burner. The preferred version of this embodiment includes the step of saving the playlist as a database file for storage upon the computer readable storage media.

In its most basic form, the computer program product accesses the database and performs the steps described above in connection with the method of the present invention. The computer program product may be a separate executable file that is stored on a personal computer or network, or it may be part of the media player described and claimed herein.

In a preferred embodiment of the computer program product, the product is downloaded onto an Internet Protocol server with a connection to the Internet and is multiplexed to allow a multitude of users to build and execute individualized playlists from media files stored upon the server. It is envisioned that this embodiment would be readily applicable to current and future content providers, such as record companies, who could use the program product as part of a music subscription or download service.

Finally, the media player of the present invention integrates that computer program product with a means for reading the playlist and a means for executing the output files. This media player may, itself, be a computer program product, such as WinAmp or Windows Media Player, or may be a standalone device, such as a portable compact disc player, home theater receiver, “boom box”, or the like.

In some embodiments, the media player is a network computer that is accessed by a hand held device, such as a PDA, cellular phone or the like, through which the user can manage playlists. In others, such as when the media player is installed in a “smart home”, the network computer is accessed through control boxes hard wired into each room, which allow the occupants of each room to control the music or other media being executed in that room.

Therefore, it is an aspect of the present invention to provide a means to automatically and autonomously add media files to a playlist.

It is a further aspect of the invention to provide a means for creating a playlist that does not limit each media file to a single playlist.

It is a further aspect of the invention to provide a means for creating a playlist that does not create static playlists list akin to traditional records or tapes.

It is a further aspect of the invention to provide a means for creating a playlist that takes the user's level of enjoyment of a particular song into account when building the list.

It is a further aspect of the invention to provide a means for creating a playlist that allows the playlist to be randomized such that the same stale songs are less likely to be repeated.

It is a further aspect of the invention to provide a means for creating a playlist that allows playlists to be created based upon a variety of search criteria, including media style or personal keyword

It is a further aspect of the invention to provide a means to add a rating descriptor to a file in order to execute files based on aesthetic quality.

It is a further aspect of the invention to provide a means to add one or more adjective descriptors to an output file in order to execute files based on mood or genre.

It is a further aspect of the invention to provide a means to add a time descriptor to an output file in order to execute files based on infrequency.

It is a further aspect of the invention to provide a means to add an artist descriptor to an output file in order to execute files based on artistic integrity.

These aspects of the invention are not meant to be exclusive and other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is one embodiment of a database accessed in the method and computer program product of the present invention.

FIG. 2 is a flowchart of the menu structure of preferred computer program product of the present invention.

FIG. 3 is a screenshot of the playlist menu of the preferred computer program product of the present invention.

FIG. 4 is a screenshot of the playlist properties menu of the preferred computer program product of the present invention.

FIG. 5 is a screenshot of the playlist tracks menu of the preferred computer program product of the present invention.

FIG. 6 is a screenshot of the track properties menu of the preferred computer program product of the present invention.

FIG. 7 is a screenshot of the library properties menu of the preferred computer program product of the present invention.

### DETAILED DESCRIPTION OF THE INVENTION

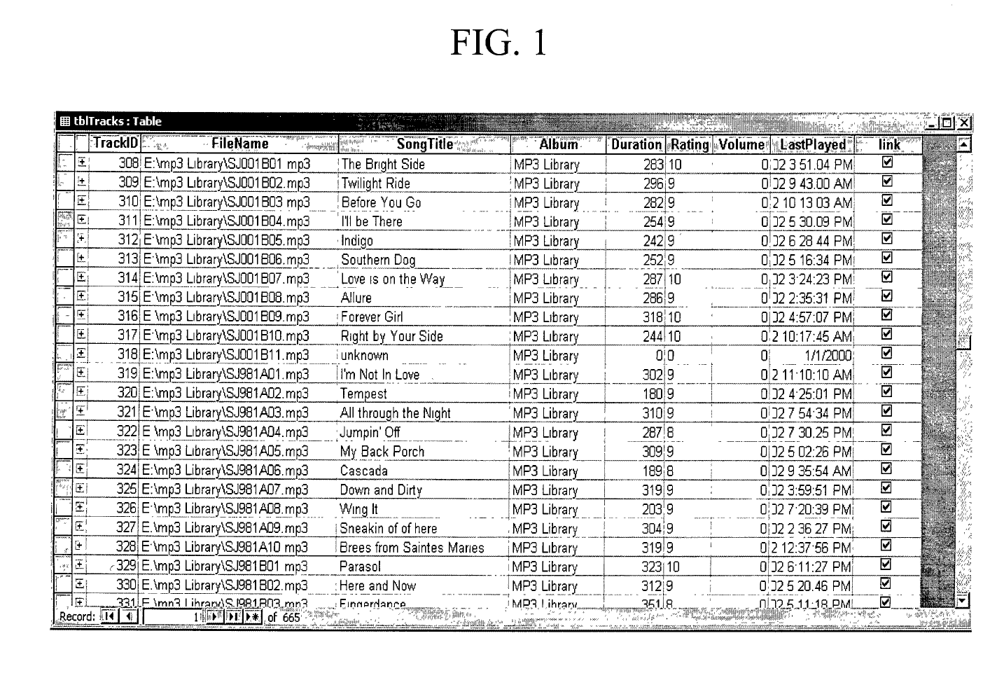

The basic method for creating a playlist includes the step of obtaining a database of output files. This database contains a plurality of fields that correspond to descriptors of the output files that may be executed by the user, and will include at least enough fields to accept a rating descriptor and time descriptor. However, as shown the sample database of FIG. 1, it is preferred that fields to accept other information, such as file name, location, track ID, title, duration, and the like, also be included in the database. In the preferred embodiment, the database is a Microsoft® Access® database and, accordingly, the database fields may be organized and manipulated in a variety or known ways. However, it is recognized that other database formats, including those of far lesser complexity, may be used to achieve similar results.

The output files listed in the database may be any common types of media output files that a user might sort and execute using a playlist. For example, if the playlist were a music playlist, the listed output files would likely be “mp3” or “wav” type files from which the playlist would be formed. If it were a playlist for a slideshow of digital photographs, the files may be BMP, JPG, GIF, TIFF, or other art recognized graphics formats. If it were a playlist of home movie clips, it might include QuickTime® movie files, MPEG, AVI, or other current or future format for these types of media files.

In some embodiments, the database is stored on a user's media player, such as a hard drive of a computer or memory chip of a portable player, or is stored on a memory storage device, such as a CD ROM, ZIP disc, or the like, that is directly connected to the media player. In others, it is stored in the memory of a handheld device, such as a PDA, cellular phone or handheld remote, and accessed directly therefrom. In these situations, the database is accessed without any remote communication being required, although in cases where the database is remote from the media player there would, obviously, be a need to communicate the resulting playlist to the player for execution. In others, the database is remotely stored on a network drive, Internet or Intranet, or other source to which a user has access, in which case the database must be accessed through some remote communication.

In the basic method, a rating descriptor and a time descriptor, each corresponding to at least one output file, are assigned to fields of the database. The rating descriptor represents a user's personal assessment of the desirability of execution of an output file, and is used to filter undesired files from a later created playlist. This descriptor is preferably a numerical or alphabetical rating; ex. 1-10 or A-F, as such types of ratings are relatively easy to sort. However, is recognized that the rating descriptor may be a word such as “excellent”, “good”, “fair”, “poor”; “frequent”, “moderate”, “infrequent”, or other logical groups of choices, that would equate to the desirability of executing the output file, could be used to achieve similar results.

The time descriptor may be used in a number of ways and, therefore, may be used to represent a number of different time values. In the database of FIG. 1, the time descriptor corresponds to a time last played of an mp3 type file. However, in other databases it may represent the time of a file's most recent download, creation, modification, or other user set value. In still others, the time descriptor may represent the duration of time required to play an audio or video file. In the initial assignment of descriptors, this time descriptor is preferably set to an initial default value and, thus, may be likewise be used as an descriptor of whether the output file had ever been executed. As described below, in the preferred embodiment, this time descriptor is later updated based upon the time of execution of the file in order to allow the playlist to be organized based, at least in part, upon the last time that the file was executed.

The output files are organized into the playlist based upon the rating descriptor, time descriptor, or both descriptors, of each output file. For example, if a user chooses to have a playlist generated solely based upon output file time descriptors, then a playlist would be formed that sorts files in order of least recent execution, most recent execution, execution within a certain date range, or the like. Similarly, during randomization the organization step may take time descriptors into account by increasing the likelihood of executing a file that is infrequently or frequently executed. If a user chooses to have a playlist generated solely based upon output file rating descriptors, then a playlist would be formed that sorts files by their ratings, with some secondary means of sorting, such a randomization, alphabetization, or the like, used to sort files having the same rating descriptor.

The preferred method utilizes a plurality of computerized forms to visually communicate input prompts to a user to allow the various fields to be filled with various descriptors. Those skilled in the art would recognize that other means of communicating an input prompt to a user could be used, but this method utilizes such forms as current computer operating systems have made it a familiar sight. The form may ask a user to specify a rating descriptor, a time descriptor, an adjective descriptor, an artist, a genre, a location descriptor for tracking an output file's location on a drive, or any other relevant topic by which to organize a playlist. Further, the form is capable of allowing the user to change any descriptors associated with an output file at that instant, or deleting an output file from a playlist.

In the preferred method, the organizing step involves the user specifying one or more descriptors and then organizing the output files into the playlist based upon the specified descriptor or descriptors of each output files. For example, if rating descriptors alone are used, output files with an adequate rating are retained in the playlist, while the remaining output files are excluded. If adjective descriptors and rating descriptors are used, only those output files with the adjective descriptors and rating descriptors requested by the use are included.

After organizing, the preferred method involves the step of communicating the playlist to a means of executing the output files. The means for executing an output file is preferrably a decoder designed to execute the particular type of output file. For example, if “mp3” type files make up the output files in the playlist and the method were performed by an integral media player, this embodiment may individually communicate a location of each song on a playlist to a decoder, such as the Nitrane decoder described above, which would execute each individual file in the order in which they are communicated. In other embodiments, the entire playlist is communicated from a separate device to a media player, such as Windows Media Player, which includes an integral decoder. Once communicated, the media player would individually communicate a location of each song on a playlist to a decoder, which would execute the output files in the order specified by the playlist.

The preferred method updates the time descriptor of each file after the file has been executed. The manner in which this is accomplished will vary depending upon the manner in which the playlist is created and communicated. For example, in embodiments where the playlist is communicated one file at a time to a decoder, this time descriptor is preferably the time that the file is communicated, and the database field corresponding to this file is updated substantially contemporaneously with the communication of the file. In some embodiments in which the entire playlist is communicated, the media player sending the files to the decoder updates an internal version of the database contemporaneously with the execution and the new data exported prior to the next re-run of the playlist. In others, the time descriptors in the database used to create the playlist are automatically updated based upon a last accessed date stored by a computer operating system in the device upon which the output file is stored. This option may be desirable in these circumstances, as it avoids compatibility problems with third party media players and read only memory devices.

It is preferred that the method of the present invention be performed by an interactive computer program product. This computer program product may be a stand-alone application, which would include the decoder and all other necessary components to allow the output files to be executed. However, in the preferred embodiment, the program product is integrated with an existing application, such as Windows Media Player, to perform its function.

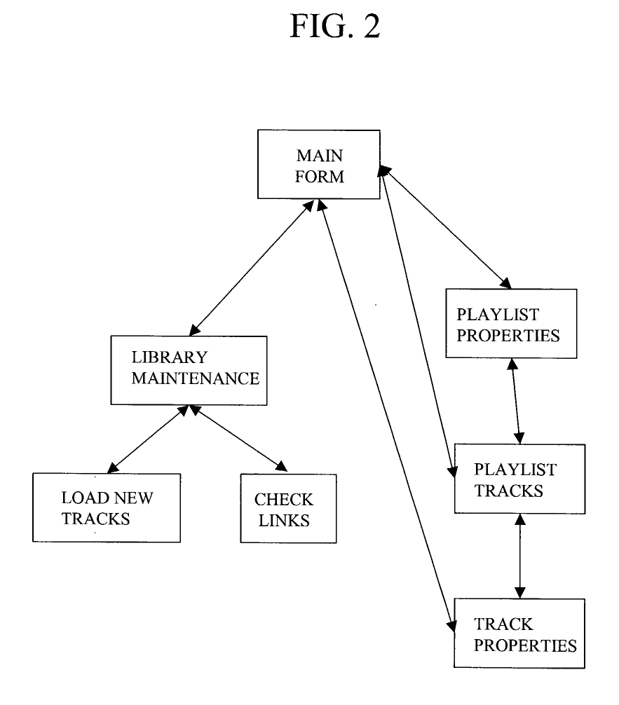

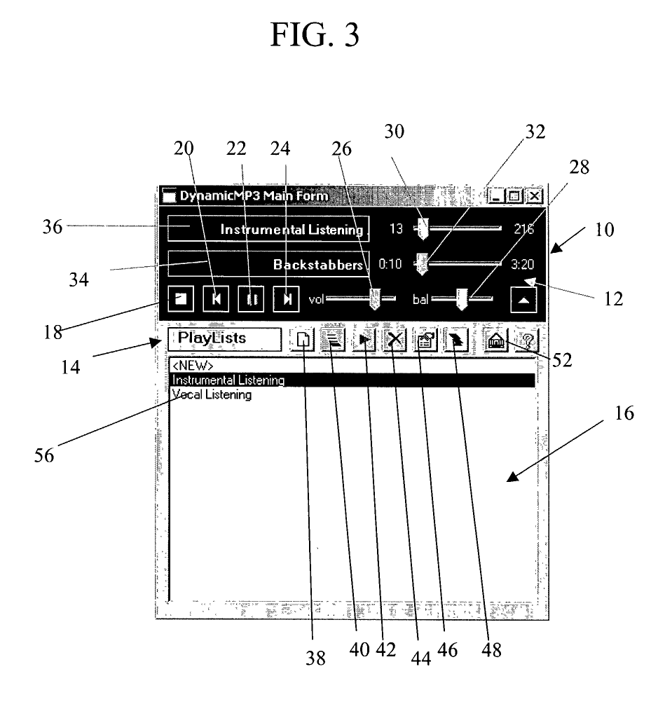

Referring now to FIGS. 2-7, the preferred computer program product of the present invention is described. As noted above, FIG. 2 is a flowchart of the navigation structure of the preferred computer program product, while FIGS. 3-7 are screenshots of the preferred forms that correspond to the navigation structure. These forms are used to specify descriptors and to perform the other functions of the method.

The preferred computer program product is coded to manage the generation of playlists for the execution of mp3 type audio files and, therefore, has a number of features specific to these types of playlists. However, it should be understood that other computer program products could be readily developed to utilize the methods of the present invention to generate other types of playlists.

As shown in FIGS. 2 and 3, the preferred program product has a main form 10, which serves as the starting point for use of the program. The preferred main form 10 includes a player portion 12, a navigation portion 14, and a playlist selection portion 16, which each serve different purposes.

The player portion 12 is preferably a graphical user interface that identifies and controls the playing of the tracks organized by the playlist. In the preferred embodiment, the player portion 12 is simply a shell that utilizes the functionality of Windows Media Player to decode and execute the tracks. Thus, it includes icons representing basic controls such as stop track 18, go to start of track 20, pause 22, skip track 24, volume 26, and balance 28. The preferred player portion 12 includes a playlist name field 36, showing the name of the playlist, and a corresponding playlist counter 30 showing the total number of tracks in the playlist and the track being played. In addition, a track name field 34 and corresponding track counter 32, showing total play time for the track and the time already played, are presented. It is understood that the controls and information fields found in the preferred player portion 12 are fairly minimalist, and that other types of filtering and equalizing controls, such as those found in more advanced mp3 player programs, may be integrated to enhance the user's control over the playing of audio files.

The playlist selection portion 16 includes a list 56 of all playlists that have been developed by a particular user. This allows a user to quickly choose a personalized playlist from those already generated, avoiding having to rebuild playlists each time the application is utilized.

The navigation portion 14 is included in all forms described herein and, in each form, includes a plurality of the icons that perform specific functions particular to the form being viewed. In the main form 10, the “new” icon 38 causes the program to open the playlist properties form 68 to allow a new playlist to be created. The “open” icon 40, active only when a playlist in the playlist selection portion 16 has been selected, causes the program to open the playlist properties form to allow the selected playlist to be reviewed and edited. The “load playlist” icon 42, also active only when a playlist has been selected, causes the program to open the playlist tracks form 70 and also to run the selected playlist. The delete playlist icon 44 allows a selected playlist to be deleted from the list 56. The playlist properties icon 46 performs the same properties as the “open” icon 40, but will show the playlist properties for the currently played playlist if a new playlist is not chosen. The playlist tracks icon 48 opens the playlist tracks form allowing the user to view the list of tracks loaded for selected playlist. Finally, the “library maintenance” icon 52 causes the program open the library maintenance form, from which the user may spawn an asynchronous process to scan specified drives, or other possible memory locations, for music files not already included the database and causes these files to be automatically added to the database and perform other functions described below.

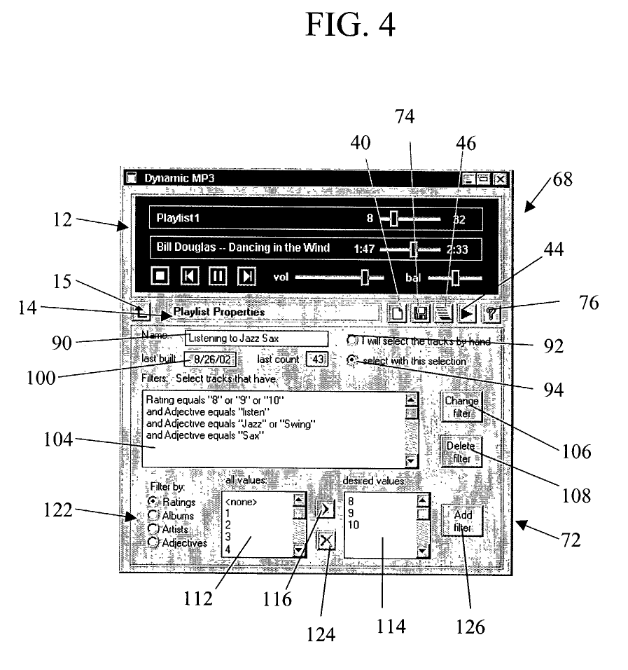

Referring now to FIG. 4, the playlist properties form 68 includes the same player portion 12 as described above with reference to the main form 10, and likewise includes a navigation portion 14. However, the navigation portion 14 of the playlist properties form 68 includes a back icon 15, which causes the main form 10 to open, and other icons directly applicable to the playlist properties. Further, a playlist-editing portion 72 replaces the playlist selection portion 16 of the main form 10.

The navigation portion 14 of the playlist properties form 68 includes the same new icon 40, load playlist icon 46 and play icon 44, as described above with reference to FIG. 3. However, it replaces all other icons with a “save” icon 74, which allows the current playlist specification to be saved, and a “help” icon 76, which provides access to help files related to specifying playlist properties.

The playlist editing portion 72 includes a plurality of icons, radio buttons and text boxes that allow a playlist to be specified and created. A name text box 90 shows the name of the playlist being edited. When building a new playlist, a user will first choose a name for entry into the name text box 90, while an existing playlist name will appear when an existing list is to be edited. The last built text box 100 and last count text box 102 are automatically filled by the program and represent the date the playlist was last edited and the number of tracks included in that playlist, respectively. Thus, these text boxes 100, 102 will only have data therein when the form 68 is used to edit an existing playlist and will preferably be blank when a new playlist is created.

A pair of radio buttons 92, 94 allow a user to determine the manner in which the playlist is to be created. If the manual selection button 92 is chosen, the filtering functions of the program are disabled and the user manually selects tracks for inclusion in the playlist in a manner similar to those of some current media players. If the “select with this selection” button 94 is chosen, the playlist is created using the filters described below.

The filters list box 104 list the individual filters that make up the playlist selection. By selecting a particular filter within the list box 104 and choosing the change filter icon 106 or delete filter icon 108, any of the current filters may be edited or deleted. If the update filter icon 106 is chosen, the “filter by” radio button 122 for the chosen descriptor is highlighted and the lower filter update list boxes 110, 112 are enabled, allowing the filter values for the chosen descriptor to be altered.

The “all values” list box 110 show a list of all distinct values available for the chosen filter to be edited, with each capable of being chosen and added to the values to be filtered via the filter “add” icon 116. As shown in FIG. 4, the ratings descriptor filter is being edited and, therefore, the values shown in the all values list box 100 are values corresponding to song ratings. However, if another of the descriptors were edited, the all values list box 100 would list all possible values for the chosen descriptor. The preferred program is coded to search for all unique values of the chosen descriptor that are found within the database and will automatically display a list of these unique values in the all values list box 110. However, in other embodiments, the user may manually add filter values to the list, or the list may be eliminated and the values entered via a text box.

The desired values list box 112 shows a list of filter values that have already been selected from the all values list box 110. The individual values making up this list may be removed from the list by selecting the value and choosing the delete filter icon 124, while values may be added in the manner described above. Once the desired values list box 112 includes all values sought to be used in filtering the output files the “Add filter” icon 126 is chosen and the edited filter replaces the original filter in the filters list box 104.

In order to add a new filter to the filters list box 104, a user would simply select the desired filter by radio button 122, which would cause the all values list box 110 to display the values for that descriptor and the desired values list box 112 to display no chosen values. The desired values would then be chosen in the manner described above and the add filter icon 126 selected to add the filter to the filters list box 104.

In the preferred program, each filter is internally interpreted as an exclusive “OR” of all values; i.e. a filter of adjectives that included multiple values of a descriptor would search for output files having any of the listed values. Conversely, each new filter is internally interpreted as an exclusive “AND” with regard to all other filters; i.e. any output files not meeting all of the filters would be filtered out. Using this method, the search string shown in the filters list box 104 of FIG. 4 would be interpreted by the preferred program as a search for output files having (1) ratings of 8, 9 or 10; and (2) the adjective “listen”; and (3) at least one of the adjective “Jazz” and the adjective “Swing”; and (4) the adjective “Sax”. However, in some embodiments the program is further coded to perform Boolean searches using standard AND, OR, NOT, ANDNOT and ORNOT operators. In these embodiments, additional icons or list boxes (not shown) may be used to build advanced Boolean search strings, eliminating the need to utilize the internal logic of the preferred program.

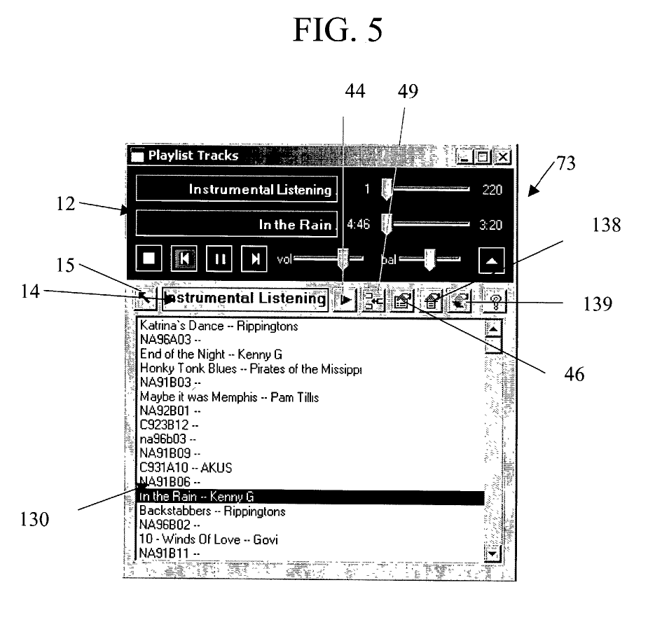

Referring now to FIG. 5, the playlist tracks form 73 again includes the same player portion 12 as described above with reference to the main form 10 and playlist properties form 68, and likewise includes a navigation portion 14. However, the navigation portion 14 of the playlist tracks form 73 includes icons directly applicable to the playlist properties, and a track selection portion 130 replaces the playlist selection portion 16 of the main form 10. The track selection portion 130 contains a list of all tracks within the playlist, which may be moved upward, or downward within the playlist, or manually eliminated from the playlist by the user.

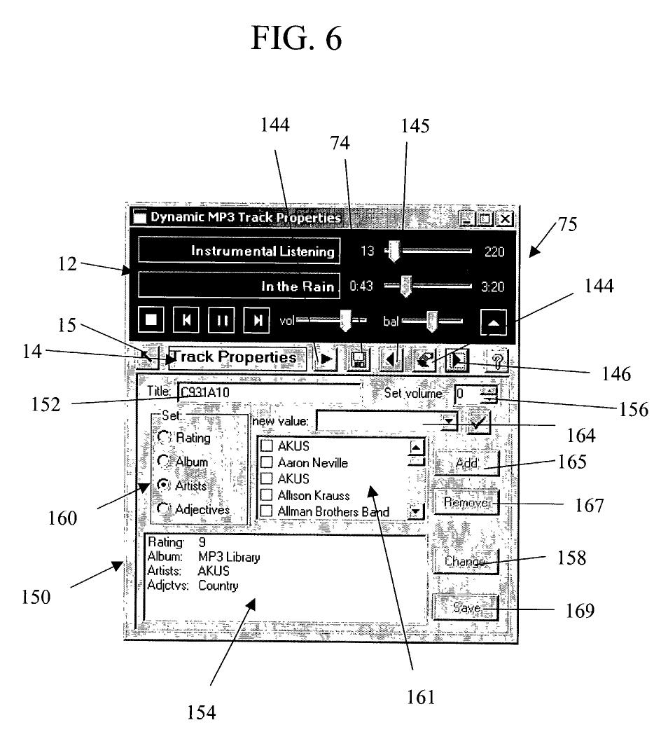

The navigation portion 14 of the playlist tracks form 73 includes a play icon 144, which causes a specific selected track in the displayed list of tracks to be played or, if no specific track is selected, to play the playlist in order. An insert track icon 49 causes the program to adds selected tracks to the playing list immediately following the playing track. A playlist properties icon 46 performs the same function as described with reference to FIG. 3. A track properties icon 138 causes a track properties form 75, shown in FIG. 6, to open and display the properties of the selected track. Finally, a bulk track properties icon 139 causes the track properties form 75, or specialized version thereof, to open and the properties of multiple selected tracks to be changed simultaneously.

Referring now to FIG. 6, the track properties form 75 again includes the same player portion 12 as described above with reference to the main form 10 and playlist properties form 68, and includes a navigation portion 14 that includes icons directly applicable to the track properties. In this form 75, the track properties portion 150 replaces the playlist selection portion 16 of the main form 10.

The navigation portion 14 of the track properties form 75 includes a play icon 144, which causes current play to be interrupted and a specific selected track whose properties are shown to be played. A save icon 74 causes and changes in properties to be stored. A show properties of previous track icon 145 and show properties of next track icon 146 allow the user to navigate through the tracks in the playlist to change properties without the need to return to the playlist tracks form 73. Finally, a bulk track properties icon 139 performs the same function as described above with reference to FIG. 5.

The track properties portion 150 allows information about the displayed track to be edited and includes a title text box 152, showing the title of the track, and a track properties list box 154 showing all descriptors that have been assigned to the track and that are editable by the user, including a volume descriptor that may be set by entering a numerical value in the set volume text box 156 or toggling the buttons up and down to scroll through available choices. It is noted that the time descriptor is not user settable in the preferred program product, but rather initially defaults to the creation date of the track and is updated automatically by the program whenever the track is played.

In order to alter any of the descriptors shown in the track properties list box 154, the user will select that descriptor in a manner similar to that describe above with regard the selection of filters from the playlist properties form 68 and the change property icon 158 is selected. This results in the set property radio button 160 to correspond to the chosen descriptor, and the “check the desired values” list box 162 to display all choices for that particular descriptor that are found in the database. The user may then choose one of these values or manually add a new value into the new value text box 164 and hit the add icon 165, which causes that value to be added to the value list in the “check the desired values” list box 162. Similarly, a chosen value may be deleted by choosing the remove icon 167. After all desired changes are made, the save icon 169 is selected and the new descriptors are saved.

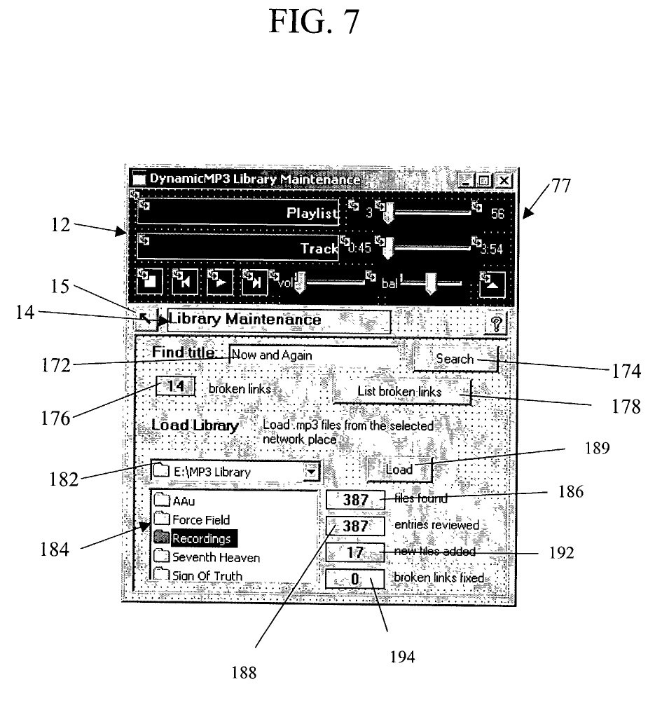

Referring now to FIG. 7, the library maintenance form 77 again includes the same player portion 12 as described above, and includes a navigation portion 14 that only includes a back icon 15, taking the user back to the main form 10. In this form 77, the library properties portion 170 replaces the playlist selection portion 16 of the main form 10.

The library properties portion 170 includes a find title text box 172 and a search icon 174, which allow the user to search the database for tracks by song title. In order to perform this search, the user will enter the start of a song title, or nothing, and press search. This causes a playlist tracks form 73 to open and display all matching tracks in alphabetical order. The search is preferably case insensitive and matches from the start of the song titles for as many characters as are entered in the text box. The broken links text box 176 is automatically generated and will show the number of broken links in the database, while the list broken links icon 178 causes a playlist tracks form 73 to open and display all tracks having broken links in alphabetical order.

The drop-down list 182 and corresponding list box 184 function in much the same way as the “My Computer” Open dialog in the Microsoft Windows® operating system. By selecting a directory and choosing the load icon 189, the selected directory will be searched, including its sub-directories, for mp3 type files. The four text boxes 186, 188, 192 and 194 to the right of the list box 184 provide status/progress information. The files found text box 186 is automatically incremented as .mp3 are found in the search directories. The entries reviewed text box 188 will begin to increment after all directories have been searched, and will be incremented as files are compared, one by one, to entries in the library. If a matching entry is found, the file will be ignored. If no matching entry is found, broken links will be reviewed for matching filenames and creation dates. During this process, it is preferred that exact matches are taken to mean the file was moved to a new location, and the file path of the track will be changed to match this new location, thereby restoring the link. If no matching broken link is found, then the file will be added to the database. The broken links fixed text box 194 will be automatically incremented to correspond to the number of links that have been fixed while the new titles added text box 192 is automatically incremented to correspond to the number of new files that have been added. When the number in the entries reviewed text box 188 equals the number in the files found text box 186, the process is complete.

Features of the present inventions have been designed to co-operate with a network. In fact, in a preferred embodiment of the computer program product, the product is downloaded onto an Internet Protocol server with a connection to the Internet and is multiplexed to allow a multitude of users to build and execute individualized playlists from media files stored upon the server. For example, there are many Internet sites that offer media downloads. If a computer user obtains access to a media site having a database of output files, the present invention would allow the user to generate a playlist based upon the output files in the database on that site's physical drive. The site might provide any relevant output file descriptors, while a user could individually modify descriptors and save these in a personalized database on the server, or on their own hard drive, for use when accessing the site. This personalized database could then be updated, either automatically or using the library maintenance form 77 to update the location descriptors of each track each time the site is accessed.

It is envisioned that the playlists created by the present invention may be downloaded to anything capable of memory storage. Accordingly, the present invention is applicable to devices other than computers. In some embodiments, a media player integrates the computer program product with a means for reading the playlist and a means for executing the output files. This media player may, itself, be a computer program product, such as Windows Media Player, or may be a standalone device, such as a portable compact disc player, home theater receiver, “boom box”, or the like. In other embodiments, the media player is a network computer that is accessed by a hand held device, such as a PDA, cellular phone or the like, through which the user can manage playlists and direct the playing of output to a specified location, such as a room of a house, a network computer, or to the handheld device itself. In others, such as when the media player is installed in a “smart home”, the network computer is accessed through control boxes hard wired into each room, which allow the occupants of each room to control the music or other media being executed in that room or other rooms within the home.

Finally, still another embodiments of the present invention organize the playlists and send these lists to a means for writing to a computer readable storage media, such as a CD burner. The preferred version of this embodiment includes the step of saving the playlist as a database file for storage upon the computer readable storage media such that the database can be accessed in the same manner as a database on a network drive.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A method for creating a playlist comprising the steps of:
accessing a database comprising a plurality of fields coded to accept at least two descriptors corresponding to each of a plurality of output files;
assigning a rating descriptor to at least of one of said plurality of fields of said database;
assigning a time descriptor to at least of one of said plurality of fields of said database; and
organizing said output files into said playlist based upon at least one of said rating descriptor and said time descriptor of each of said plurality of output files;

2. The method as claimed in claim 1 further comprising the step of assigning and at least one adjective descriptor to at least one of said plurality of output files;

3. The method as claimed in claim 2 wherein said organizing step comprises organizing said output files into said playlist based upon said rating descriptors and said at least one adjective descriptor of each of said plurality of output files.

4. The method as claimed in claim 2 further comprising the steps of:
communicating said playlist to a means of executing said output files;
executing at least one of said output files; and
updating said time descriptor corresponding to a time of last execution of each of said output files executed during said executing step.

5. The method as claimed in claim 4 wherein said organizing step comprises organizing said output files into said playlist based upon said rating descriptors, said at least one adjective descriptor, and said time descriptor of each of said plurality of output files.

6. The method as claimed in claim 4 wherein said organizing step comprises organizing said output files into said playlist based upon said time descriptors and said at least one adjective descriptor of each of said plurality of output files.

7. The method as claimed in claim 2 wherein at least one of said steps of assigning a rating descriptor and assigning an adjective descriptor comprises the steps of:
communicating an input prompt to a user;
accepting an input from said user; and
updating at least one of said rating descriptor and said adjective descriptor of at least one of said output files based upon said input from said user.

8. The method as claimed in claim 7 wherein said step of communicating an input prompt to a user comprises communicating a form to a computer monitor.

9. The method as claimed in claim 1 further comprising the step of prompting a user to remove one of said output files from said playlist.

10. The method of claim 1 further comprising the step of assigning a location descriptor to each of said plurality of output files.

11. The method as claimed in claim 1 further comprising the step of assigning an artist descriptor to each of said plurality of output files.

12. A computer program product for creating a playlist from a database comprising a plurality of output files, said computer program product comprising:
program means for assigning a rating descriptor to each of said plurality of output files;
program means for assigning a time descriptor to each of said plurality of output files; and
program means for organizing said output files into said playlist based upon at least one of said rating descriptors and said time descriptors of each of said plurality of output files.

13. The computer program product as claimed in claim 12 further comprising means for assigning and at least one adjective descriptor to at least one of said plurality of output files.

14. The computer program product as claimed in claim 13 wherein said program means for organizing positions of said output files into said playlist comprises program means for organizing positions of said output files into said playlist based upon said rating descriptors and said at least one adjective descriptor of each of said plurality of output files.

15. The computer program product as claimed in claim 13 further comprising:
program means for communicating said playlist to a means of executing said output files; and
program means for updating said time descriptor corresponding to a time of last execution of each of said output files.

16. The computer program product as claimed in claim 13 wherein said program means for organizing positions of said output files into said playlist comprises program means for organizing positions of said output files into said playlist based upon said rating descriptors, said at least one adjective descriptor, and said time descriptor of each of said plurality of output files.

17. The computer program product as claimed in claim 13 wherein said program means for organizing positions said output files into said playlist comprises program means for organizing positions of said output files into said playlist based upon said time descriptors and said at least one adjective descriptor of each of said plurality of output files.

18. The computer program product as claimed in claim 13 wherein at least one of said program means for assigning a rating descriptor and assigning an adjective descriptor comprises:
program means for communicating an input prompt to a user;
program means for accepting an input from said user; and
program means for updating one of said rating descriptor and said adjective descriptor of at least one of said output files based upon said input from said user.

19. The computer program product as claimed in claim 18 wherein said program means for communicating an input prompt to a user comprises a form displayed on a monitor.

20. The computer program product as claimed in claim 12 further comprising a means for deleting that prompts a user to remove one of said output files from said playlist.

21. The computer program product as claimed in claim 12 further comprising a means for assigning a location descriptor to each of said plurality of output files.

22. The computer program product as claimed in claim 12 further comprising a means for assigning an artist descriptor to each of said plurality of output files.

23. A media player comprising:
a computer program product for creating a playlist from a database comprising a plurality of output files, said computer program product comprising:
program means for assigning a rating descriptor to each of said plurality of output files;
program means for assigning a time descriptor to each of said plurality of output files; and
program means for organizing said output files into said playlist based upon at least one of said rating descriptors and said time descriptors of each of said plurality of output files;
means for reading said playlist; and
means for executing said output files in an order designated by said playlist.

24. The media player as claimed in claim 23 further comprising means for assigning and at least one adjective descriptor to at least one of said plurality of output files.

25. The media player as claimed in claim 24 wherein said program means for organizing positions of said output files into said playlist comprises program means for organizing positions of said output files into said playlist based upon said rating descriptors and said at least one adjective descriptor of each of said plurality of output files.

26. The media player as claimed in claim 24 further comprising program means for updating said time descriptor corresponding to a time of last execution of each of said output files.

27. The media player as claimed in claim 24 wherein said program means for organizing positions of said output files into said playlist comprises program means for organizing positions of said output files into said playlist based upon said rating descriptors, said at least one adjective descriptor, and said time descriptor of each of said plurality of output files.

28. The media player as claimed in claim 24 wherein said program means for organizing positions of said output files into said playlist comprises program means for organizing positions of said output files into said playlist based upon said time descriptors and said at least one adjective descriptor of each of said plurality of output files.

29. The media player as claimed in claim 24 wherein at least one of said program means for assigning a rating descriptor and assigning an adjective descriptor comprises:
program means for communicating an input prompt to a user;
program means for accepting an input from said user; and
program means for updating one of said rating descriptor and said adjective descriptor of at least one of said output files based upon said input from said user.

30. The media player as claimed in claim 29 wherein said program means for communicating an input prompt to a user comprises a form displayed on a monitor.

31. The media player as claimed in claim 23 further comprising a means for deleting that prompts a user to remove one of said output files from said playlist.

32. The media player as claimed in claim 23 further comprising a means for assigning a location descriptor to each of said plurality of output files.

33. The media player as claimed in claim 23 further comprising a means for assigning an artist descriptor to each of said plurality of output files.
